(19) United States
(12) Patent Application Publication
(10) Pub. No.: US 2011/0131554 A1
(43) Pub. Date: Jun. 2, 2011

(54) APPLICATION GENERATION SYSTEM, METHOD, AND PROGRAM PRODUCT

(75) Inventors: Munehiro Doi, Kanagawa-ken (JP); Hideaki Komatsu, Kanagawa-ken (JP); Kumiko Maeda, Kanagawa-ken (JP); Masana Murase, Kanagawa-ken (JP); Takeo Yoshizawa, Kanagawa-ken (JP)

(73) Assignee: INTERNATIONAL BUSINESS MACHINES CORPORATION, Armonk, NY (US)

(21) Appl. No.: 12/955,147

(22) Filed: Nov. 29, 2010

(30) Foreign Application Priority Data
Nov. 30, 2009 (JP) 2009-271308

(51) Int. Cl. G06F 9/44

(52) U.S. Cl. 717/131

(57) ABSTRACT

A method, system and computer program product for optimizing performance of an application running on a hybrid system. The method includes the steps of: selecting a first user defined operator from a library component within the application; determining at least one available hardware resource; generating at least one execution pattern for the first user defined operator based on the available hardware resource; compiling the execution pattern; measuring the execution speed of the execution pattern on the available hardware resource; and storing the execution speed and the execution pattern in an optimization table; where at least one of the steps is carried out using a computer device so that performance of said application is optimized on the hybrid system.

### CROSS-REFERENCE TO RELATED APPLICATION

This application claims priority under 35 U.S.C. §119 from Japanese Patent Application No. 2009-271308 filed Nov. 30, 2009, the entire contents of which are incorporated herein by reference.

### BACKGROUND OF THE INVENTION

The present invention relates to a technique for optimizing an application to run more efficiently on a hybrid system. More specifically, a technique for optimizing the execution pattern of the operators and libraries of the application is shown.

Recently, hybrid systems have been set up which contain multiple parallel high-speed computers having different architectures connected by a plurality of networks or buses. Due to this diversity in architectures such as various types of processors, accelerator functions, hardware architectures, network topologies, and the like, it becomes a challenge to write compatible applications for the hybrid system.

For example, the IBM's® Roadrunner has two types of 100,000 cores. Only extremely-limited experts are able to generate the application program codes and resource mapping necessary to take this type of complicated computer resources into consideration.

Japanese Unexamined Patent Publication No. Hei 8-106444 discloses an information processor system including a plurality of CPUs which, in the case of replacing the CPUs with different types of CPUs, automatically generates and loads load modules compatible with the CPUs.

Japanese Unexamined Patent Publication No. 2006-338660 discloses a method for supporting the development of a parallel/distributed application by providing the steps of: providing a script language for representing elements of a connectivity graph and the connectivity between the elements in a design phase; providing predefined modules for implementing application functions in an implementation phase; providing predefined executors for defining a module execution type in the implementation phase; providing predefined process instances for distributing the application over a plurality of computing devices in the implementation phase; and providing predefined abstraction levels for monitoring and testing the application in a test phase.

Japanese Unexamined Patent Publication No. 2006-505055 discloses a system and method for compiling computer code written in conformity to a high-level language standard to generate a unified executable element containing the hardware logic for a reconfigurable processor, the instructions for a conventional processor (instruction processor), and the associated support code for managing execution on a hybrid hardware platform.

Japanese Unexamined Patent Publication No. 2007-328415 discloses a heterogeneous multiprocessor system, which includes a plurality of processor elements having mutually different instruction sets and structures, for extracting an executable task based on a preset dependence relationship between a plurality of tasks; allocating the plurality of first processors to a general-purpose processor group based on the dependence relationship between the extracted tasks; allocating the second processor to an accelerator group; determining a task to be allocated from the extracted tasks based on a preset priority value for each of the tasks; comparing an execution cost of executing the determined task by the first processor with an execution cost of executing the task by the second processor; and allocating the task to one of the general-purpose processor group and the accelerator group that is judged to be lower in the execution cost as a result of the cost comparison.

Japanese Unexamined Patent Publication No. 2007-328416 discloses a heterogeneous multiprocessor system, wherein tasks having parallelism are automatically extracted by a compiler, a portion to be efficiently processed by a dedicated processor is extracted from an input program being a processing target, and processing time is estimated, thereby arranging the tasks according to Processing Unit (PU) characteristics and thus enabling scheduling for efficiently operating a plurality of PUs in parallel.

Although the foregoing references of the conventional techniques disclose techniques of compiling source code for a hybrid hardware platform, the references do not disclose the technique of generating executable code optimized with respect to resources to be used or a processing speed.

### SUMMARY OF THE INVENTION

Accordingly, one aspect of the present invention provides a method for optimizing performance of an application running on a hybrid system, the method includes the steps of: selecting a first user defined operator from a library component within the application; determining at least one available hardware resource; generating at least one execution pattern for the first user defined operator based on the available hardware resource; compiling the execution pattern; measuring the execution speed of the execution pattern on the available hardware resource; and storing the execution speed and the execution pattern in an optimization table; where at least one of the steps is carried out using a computer device so that performance of said application is optimized on the hybrid system.

Another aspect of the present invention provides a system for optimizing performance of an application running on a hybrid system which (1) permits nodes having mutually different architectures to be mixed and (2) connects a plurality of hardware resources to each other via a network and, the system includes: a storage device; a library component for generating the application stored in the storage device; a selection module adapted to select a first user defined operator from a library component within the application; a determination module adapted to determine at least one available hardware resource; a generation module adapted to generate at least one execution pattern for the first user defined operator based on the available hardware resource; a measuring module adapted to measure an execution speed of the execution pattern using the available hardware resource; and a storing module adapted to store the execution speed and the execution pattern in an optimization table.

Another aspect of the present invention provides a computer readable storage medium tangibly embodying a computer readable program code having computer readable instructions which when implemented, cause a computer to carry out the steps of: selecting a first user defined operator from a library component within the application; determining at least one available hardware resource; generating at least one execution pattern for the first user defined operator based on the available hardware resource; compiling the execution pattern; measuring the execution speed of the execution pattern on the available hardware resource; and storing the execution speed and the execution pattern in an optimization table.

### BRIEF DESCRIPTION OF THE DRAWINGS

FIG. 1 is a diagram illustrating the outline of a hardware structure according to an embodiment of the present invention.

FIG. 2 is a functional block diagram according to an embodiment of the present invention.

FIG. 3 is a diagram illustrating a flowchart of processing for generating an optimization table according to an embodiment of the present invention.

FIG. 4 is a diagram illustrating an example of generating an execution pattern according to an embodiment of the present invention.

FIG. 5 is a diagram illustrating an example of a data-dependent vector representing the condition of splitting an array for parallel processing according to an embodiment of the present invention.

FIG. 6 is a diagram illustrating an example of the optimization table according to an embodiment of the present invention.

FIG. 7 is a diagram illustrating a flowchart of the outline of network embedding processing according to an embodiment of the present invention.

FIG. 8 is a diagram illustrating a flowchart of processing of allocating computational resources to user defined operators according to an embodiment of the present invention.

FIG. 9 is a diagram illustrating an example of a stream graph and available resources according to an embodiment of the present invention.

FIG. 10 is a diagram illustrating an example of required resources after allocating the computational resources to the user defined operators according to an embodiment of the present invention.

FIG. 11 is a diagram illustrating an example of allocation change processing according to an embodiment of the present invention.

FIG. 12 is a diagram illustrating a flowchart of clustering processing according to an embodiment of the present invention.

FIG. 13 is a diagram illustrating an example of a stream graph expanded by an execution pattern according to an embodiment of the present invention.

FIG. 14 is a diagram illustrating an example of allocating a kernel to a node according to an embodiment of the present invention.

FIG. 15 is a diagram illustrating a flowchart of cluster allocation processing according to an embodiment of the present invention.

FIG. 16 is a diagram illustrating an example of a hardware configuration according to an embodiment of the present invention.

FIG. 17 is a diagram illustrating an example of a route table and a network capacity table according to an embodiment of the present invention.

FIG. 18 is a diagram illustrating an example of the connection between clusters according to an embodiment of the present invention.

### DETAILED DESCRIPTION OF THE PREFERRED EMBODIMENTS

Hereinafter, preferred embodiments of the present invention will be described in detail in accordance with the accompanying drawings. Unless otherwise specified, the same reference numerals denote the same elements throughout the drawings. It should be understood that the following description is merely of one embodiment of the present invention and is not intended to limit the present invention to the contents described in the preferred embodiments.

It is an object of the present invention to provide a code generation technique capable of generating an executable code optimized as much as possible with respect to the use of resources and execution speed on a hybrid system composed of a plurality of computer systems which can be mutually connected via a network.

In an embodiment of the present invention, there are measured resources and a pipeline pitch, namely one-stage processing time for the pipeline processing required for a case where there is no optimization and a case where an optimization is applied with respect to each library component. These processing times are registered as an execution pattern. For each library component, there can be several execution patterns. Although an execution pattern which improves the pipeline pitch by increasing resources is registered, an execution pattern which does not improve the pipeline pitch by increasing resources is not preferably registered.

It should be noted that a set of programs is referred to as a library component. These library components can be written in an arbitrary program language such as C, C++, C#, or Java® and can perform a certain collective function. For example, the library component can be equivalent to a functional block in Simulink® in some cases, but in other cases, a combination made of a several functional blocks can be considered a library component.

On the other hand, an execution pattern can be composed of data parallelization (parallel degree 1, 2, 3, - - - , n), an accelerator and its use (a graphics processing unit), and a combination thereof. A user defined operator (UDOP) is a unit of abstract processing such as a product-sum calculation of a matrix.

According to the present invention, it is possible to generate an executable code optimized as much as possible with respect to the use of resources and execution speed on a hybrid system by referencing an optimization table generated based on library components.

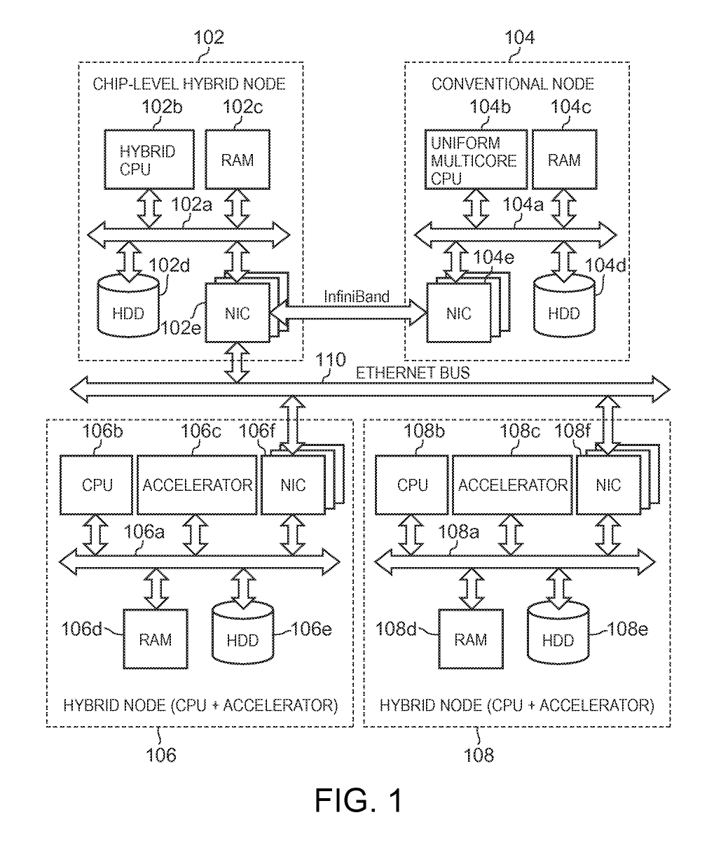

FIG. 1 shows a block diagram illustrating a hardware structure according to an embodiment of the present invention. This structure contains a chip-level hybrid node 102, a conventional node 104, and hybrid nodes 106 and 108, each having a CPU and an accelerator.

The chip-level hybrid node 102 has a structure in which a bus 102a is connected to a hybrid CPU 102b including multiple types of CPUs, a main memory (RAM) 102c, a hard disk drive (HDD) 102d, and a network interface card (NIC) 102e. The conventional node 104 has a structure in which a bus 104a is connected to a multicore CPU 104b composed of a plurality of same cores, a main memory 104c, a hard disk drive 104d, and a network interface card (NIC) 104e.

The hybrid node 106 has a structure in which a bus 106a is connected to a CPU 106b, an accelerator 106c which is, for example, a graphic processing unit, a main memory 106d, a hard disk drive 106e, and a network interface card 106f. The hybrid node 108 has the same structure as the hybrid node 106, where a bus 108a is connected to a CPU 108b, an accelerator 108c which is, for example, a graphic processing unit, a main memory 108d, a hard disk drive 108e, and a network interface card 108f.

The chip-level hybrid node 102, the hybrid node 106, and the hybrid node 108 are mutually connected via an Ethernet® bus 110 and respective network interface cards. The chip-level hybrid node 102 and the conventional node 104 are connected to each other via respective network interface cards using InfiniBand which is a server/cluster high-speed I/O bus architecture and interconnect technology.

The nodes 102, 104, 106, and 108 provided here can be any available computer hardware such as IBM® System p series, IBM® System x series, IBM® System z series, IBM® Roadrunner, or BlueGene®. Moreover, the operating system can be any available operating system such as Windows® XP, Windows® 2003 server, Windows® 7, AIX®, Linux®, or Z/OS. Although not shown, the nodes 102, 104, 106, and 108 each have interface units such as a keyboard, a mouse, a display, and the like used by an operator or a user for operation.

The structure shown in FIG. 1 is merely illustrative in the number and types of nodes and can be composed of more nodes or different types of nodes. Moreover, the connection mode between nodes can be an arbitrary structure which supplies required communication speed such as LAN, WAN, VPN via the Internet or the like.

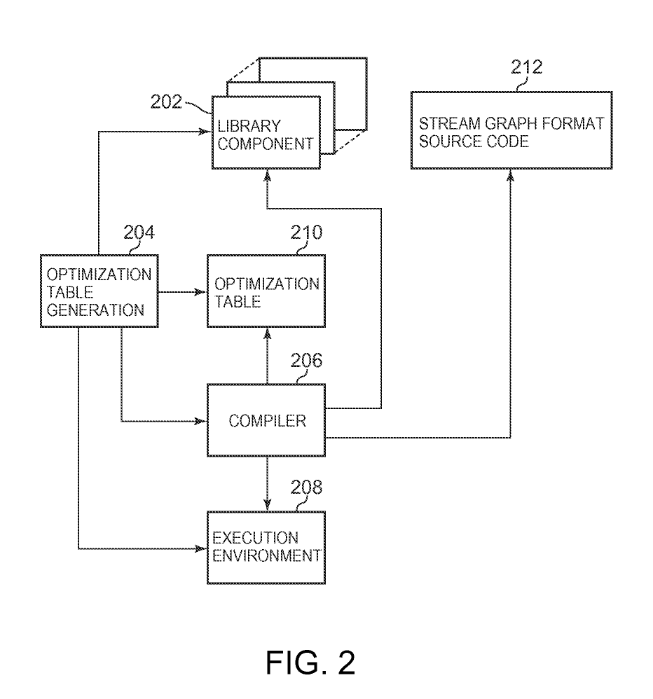

FIG. 2 shows functional blocks related to a structure according to an embodiment of the present invention. The functional blocks can be stored in the hard disk drive of the nodes 102, 104, 106, and 108 shown in FIG. 1. Alternatively, the functional blocks can be loaded into the main memory. Moreover, a user is able to control the system by manipulating the keyboard or the mouse on one of the nodes 102, 104, 106, and 108.

In FIG. 2, an example of a library component 202 is a Simulink® functional block. In some cases, a combination of a several functional blocks is considered to be one library component when viewed in units of algorithm to be achieved. The library component 202, however, is not limited to a Simulink® functional block. The library component 202 can be a set of programs, which is written in an arbitrary program language such as C, C++, C#, or Java® and performs a certain collective function. The library component 202 is preferably generated in advance by an expert programmer and preferably stored in a hard disk drive of another computer system other than the nodes 102, 104, 106, and 108.

An optimization table generation module 204 is also preferably stored in the hard disk drive of another computer system other than the nodes 102, 104, 106, and 108, and an optimization table 210 is generated with reference to the library component 202 by using a compiler 206 and accessing an execution environment 208. The generated optimization table 210 is also preferably stored in the hard disk drive or main memory of another computer system other than the nodes 102, 104, 106, and 108. The generation processing of the optimization table 210 will be described in detail later. The optimization table generation module 204 is able to be written in a known appropriate arbitrary programming language such as C, C++, C#, Java® or the like.

A stream graph format source code 212 is a source code of a program, which the user requires to execute in the hybrid system shown in FIG. 1, stored in a stream format. The typical format is represented by the Simulink® functional block diagram. The stream graph format source code 212 is preferably stored in the hard disk drive of another computer system other than the nodes 102, 104, 106, and 108.

The compiler 206 has a function of clustering computational resources according to a node configuration and a function of allocating logical nodes to the networks of physical nodes and determining the communication method between the nodes, as well as the function of compiling codes to generate executable codes, for various environments of the nodes 102, 104, 106, and 108. The functions of the compiler 206 will be described in more detail later.

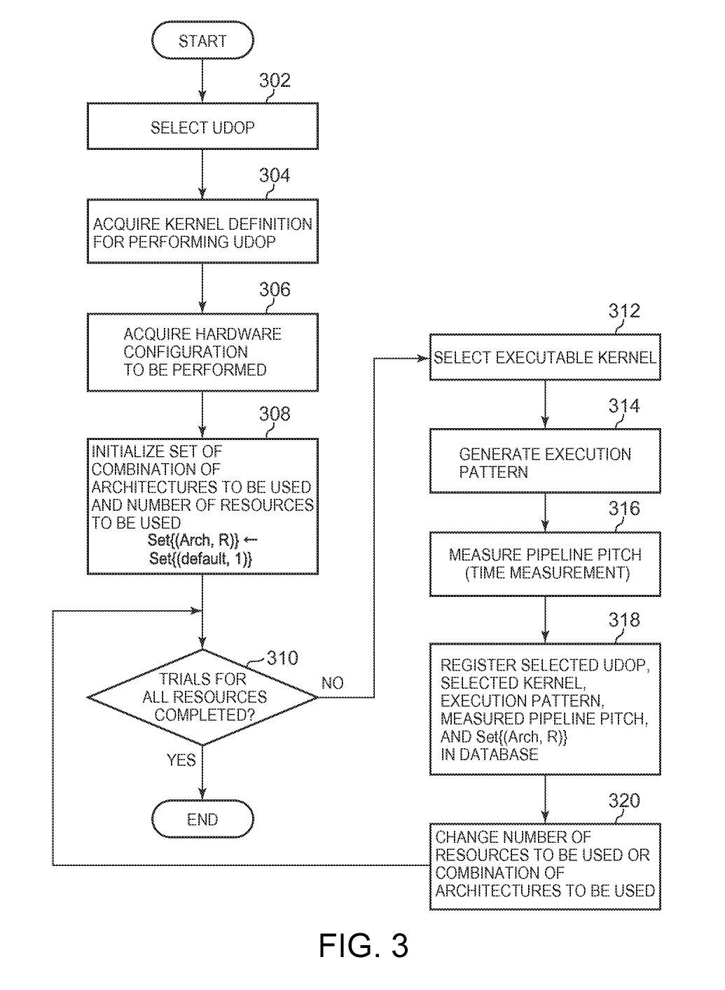

An execution environment 208 is a block diagram generically showing the hybrid hardware resource shown in FIG. 1. The following describes the optimization table generation processing performed by the optimization table generation module 204 with reference to the flowchart of FIG. 3.

In FIG. 3, in step 302, the optimization table generation module 204 selects UDOP in the library component 202, namely a unit of certain abstract processing according to an embodiment of the present invention. The relationship between the library component 202 and UDOP will be described here. The library component 202 is a set of programs for performing a certain collective function such as, for example, a fast Fourier transform (FFT) module, a successive over-relaxation (SOR) method module, and a Jacobi method module for finding an orthogonal matrix. The UDOP can be abstract processing such as, for example, a product-sum calculation of a matrix selected by the optimization table generation module 204 and used in the Jacobi method module.

In step 304, a kernel definition for performing the selected UDOP is acquired. Here, the kernel definition is a concrete code dependent on a hardware architecture corresponding to UDOP in this embodiment.

In step 306, the optimization table generation module 204 accesses the execution environment 208 to acquire a hardware configuration to be performed. In step 308, the optimization table generation module 204 initializes a set of the combination of architectures to be used and the number of resources to be used, namely Set{(Arch, R)} to Set{(default, 1)}.

Next, in step 310, it is determined whether the trials for all resources are completed. If so, the processing is terminated. Otherwise, the optimization table generation module 204 selects a kernel executable for the current resource in step 312. In step 314, the optimization table generation module 204 generates an execution pattern. An example execution pattern is described as follows:

(1) Rolling a loop (Rolling loop): A+A+A . . . A=>loop(n, A)

Here, A+A+A . . . A is serial processing of A, and loop(n, A) represents a loop of turning A n times.

(2) Unrolling a loop (Unrolling loop): loop(n, A)=>A+A+A . . . A
(3) Loops in series (Series Rolling): split_join(A, A . . . A)=>loop(n, A)

This means a change from A, A . . . A in parallel to loop(n, A).

(4) Loops in parallel (Pararell unrolling loop): loop(n, A)=>split_joing(A, A, A . . . A)

This means a change from loop(n, A) to A, A . . . A in parallel.

(5) Loop splitting (Loop splitting): loop(n, A)=>loop(x, A)+loop(n−x, A)
(6) Parallel loop splitting (Pararell Loop splitting): loop(n, A)=>split_join(loop(x, A), loop(n−x, A))
(7) Loop fusion (Loop fusion): loop(n, A)+loop(n, B)=>loop(n, A+B)
(8) Series loop fusion (Series Loop fusion): split_join(loop(n, A), loop(n, B))=>loop(n, A+B)
(9) Loop distribution (Loop distribution): loop(n, A+B)=>loop(n, A)+loop(n, B)
(10) Parallel loop distribution (Parallel Loop distribution): loop(n, A+B)=>split_join(loop(n, A), loop(n, B))
(11) Node merging (Node merging): A+B=>{A,B}
(12) Node splitting (Node splitting): {A,B}=>A+B
(13) Loop replacement (Loop replacement): loop(n,A)=>X/*X is lower cost*/
(14) Node replacement (Node replacement): A=>X/*X is lower cost*/

Depending on a kernel, all of the above execution patterns are not always generable. Therefore, in step 314, only generable execution patterns are generated. In step 316, the generated execution patterns are compiled by the compiler 206 and the resulting executable codes are executed by a selected resource in the execution environment 208 and a pipeline pitch (time) is measured.

In step 318, the optimization table generation module 204 stores the measured pipeline pitch to a database. In addition, the optimization table generation module 204 can also store the selected UDOP, the selected kernel, the execution patterns, the measured pipeline pitch, and Set{Arch, R)} in a database (such as an optimization table) 210.

In step 320, the number of resources to be used or the combination of architectures to be used is changed. For example, a change can be made in the combination of nodes to be used (See FIG. 1) or the combination of the CPU and accelerator to be used.

Next, returning to step 310, it is determined whether the trials for all resources are completed. If so, the processing is terminated. Otherwise, in step 312, the optimization table generation module 204 selects a kernel executable for the resource selected in step 320.

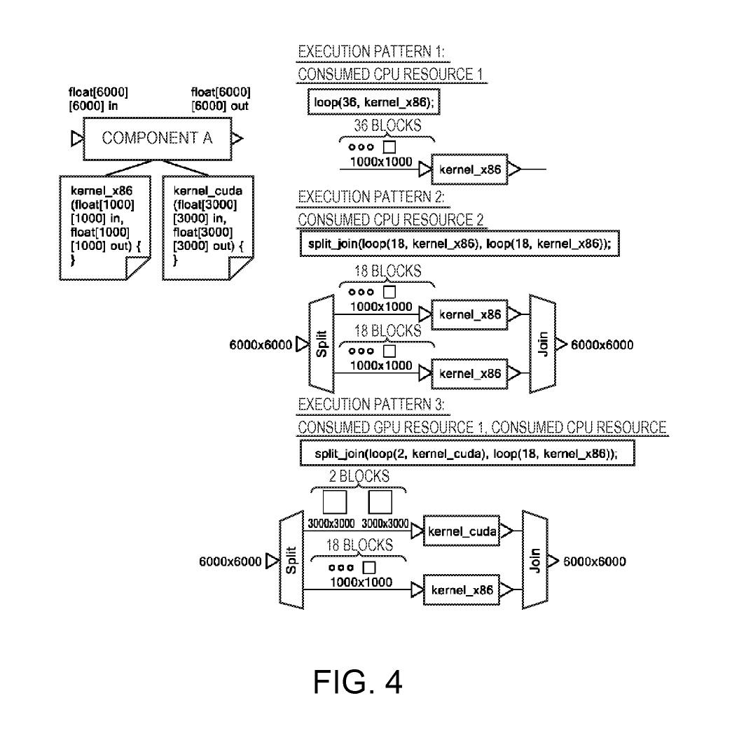

FIG. 4 shows a diagram illustrating an example of generating an execution pattern according to an embodiment of the present invention. The execution pattern has a library component A which has a large array, float[6000][6000] and focuses on the following two kernels:

(1) kernel_x86(float[1000][1000] in, float[1000][1000] out) {
...
}
and
(2) kernel_cuda(float[3000][3000] in, float[3000][3000] out) {
...
}

Above, kernel_x86 indicates a kernel which uses a CPU for the Intel® x86 architecture and kernel_cuda indicates a kernel which uses a graphic processing unit (GPU) of the CUDA architecture provided by NVIDIA Corporation.

In FIG. 4, execution pattern 1 executes kernel_x86 36 times as represented by “loop(36,kernel_x86)”. In execution pattern 2, the loop is split into two “loop(18,kernel_x86)” loops as represented by “split_join(loop(18,kernel_x86),loop(18,kernel_x86))”. After the loop is split, processing is allocated to two x86 series CPUs to perform parallel execution, and thereafter the results are joined. In execution pattern 3, the loop is also split into two “loop(2,kernel_cuda)” and “loop(18,kernel_x86)” as represented by “split_join(loop(2,kernel_cuda),loop(18,kernel_x86))” After the loop is split, processing is allocated to a cude series CPU and an x86 series CPU to perform parallel execution, and thereafter the results are joined.

Since there can be these kinds of various execution patterns, a combinatorial explosion can occur when all possible combinations are performed. Therefore, in this embodiment, possible execution patterns are performed within a range of an allowed time without performing all possible combinations.

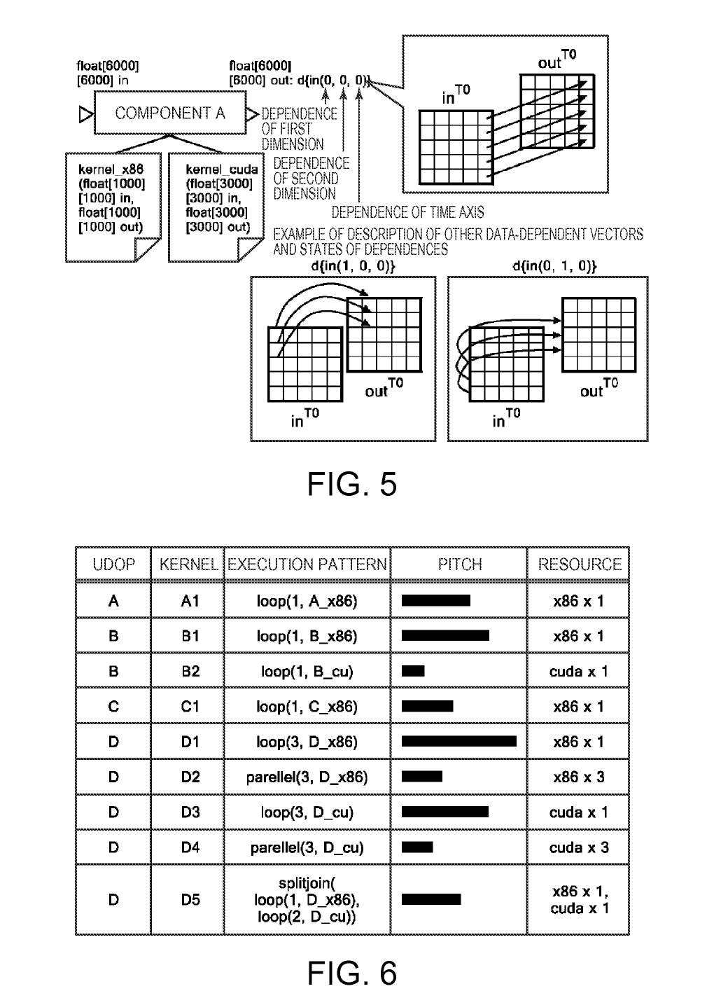

FIG. 5 shows a diagram illustrating an example condition used when splitting the array (float[6000][6000]) in the kernel in FIG. 4 according to an embodiment of the present invention. For example, when solving a boundary-value problem of a partial differential equation such as a Laplace's equation by using a large array, the elements of the calculated array have a dependence relationship with each other. Accordingly, there is a dependence relationship in splitting rows if the calculation is parallelized.

Thus, a data-dependent vector such as d{in(a,b,c)} for specifying the condition of the splitting is defined and used according to the content of the array calculation. The characters, a, b, and c in d{in(a,b,c)} each take a value of 0 or 1: a=1 indicates the dependence of the first dimension, in other words, that the array is block-split-able in the horizontal direction; b=1 indicates the dependence of the second dimension, in other words, that the array is block-split-able in the vertical direction; and c=1 indicates a dependence of the time axis, in other words, a dependence of the array on the output side relative to the array on the input side.

FIG. 5 shows an example of those dependences according to an embodiment of the present invention. In addition, d{in(0,0,0)} indicates that the array can be split in any arbitrary direction. The data-dependent vector is prepared based on the nature of the calculation, so that only an execution pattern satisfying the condition specified by the data-dependent vector is generated in step 314. FIG. 6 shows an example of the optimization table 210 generated as described above according to an embodiment of the present invention.

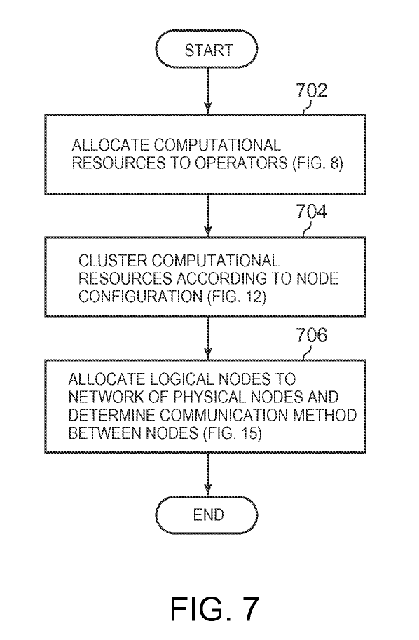

The following describes a method for generating a program executable on a hybrid system as shown in FIG. 1 by referencing the generated optimization table 210 with reference to FIG. 7 and subsequent figures. More specifically, FIG. 7 shows a general flowchart illustrating the entire processing of generating the executable program according to an embodiment of the present invention. While this method is performed by the compiler 206, it should be noted that the compiler 206 can reference the library component 202, the optimization table 210, the stream graph format source code 212, and the execution environment 208.

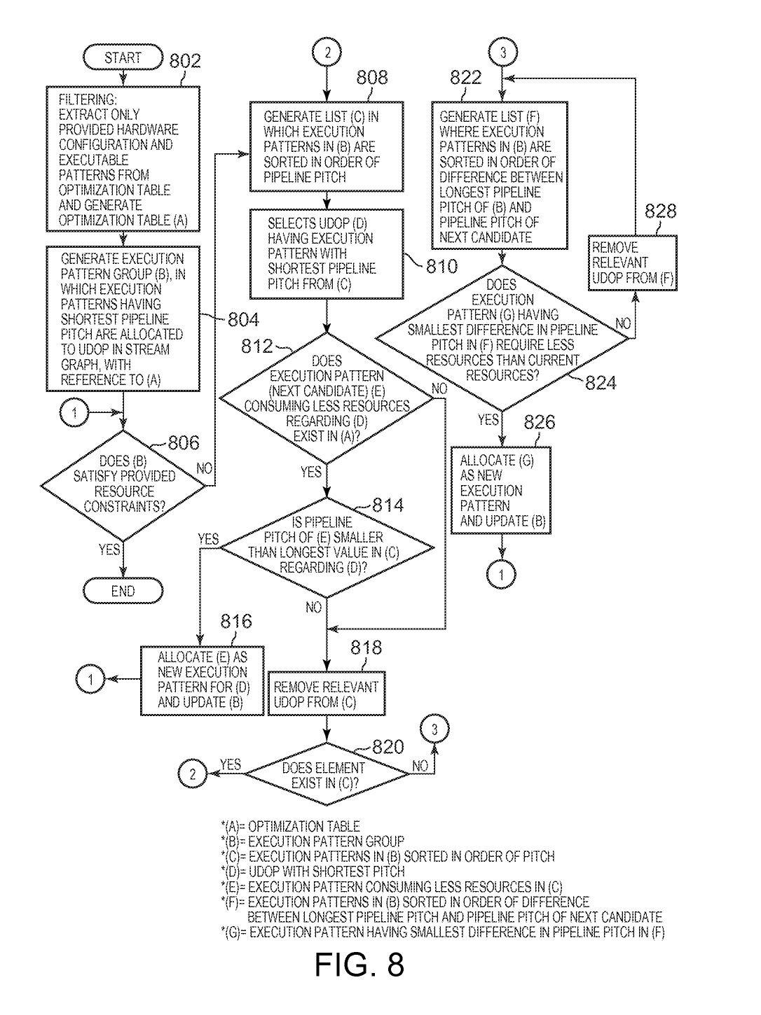

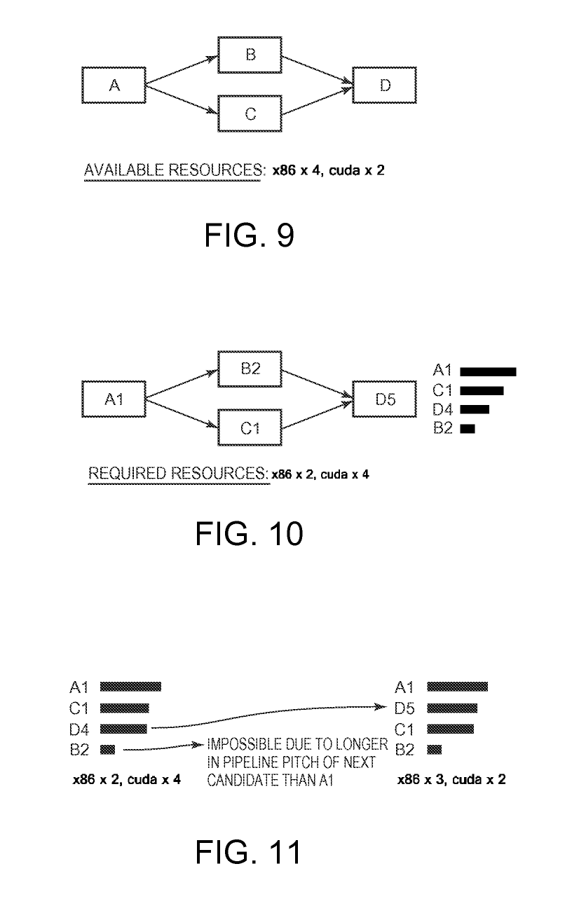

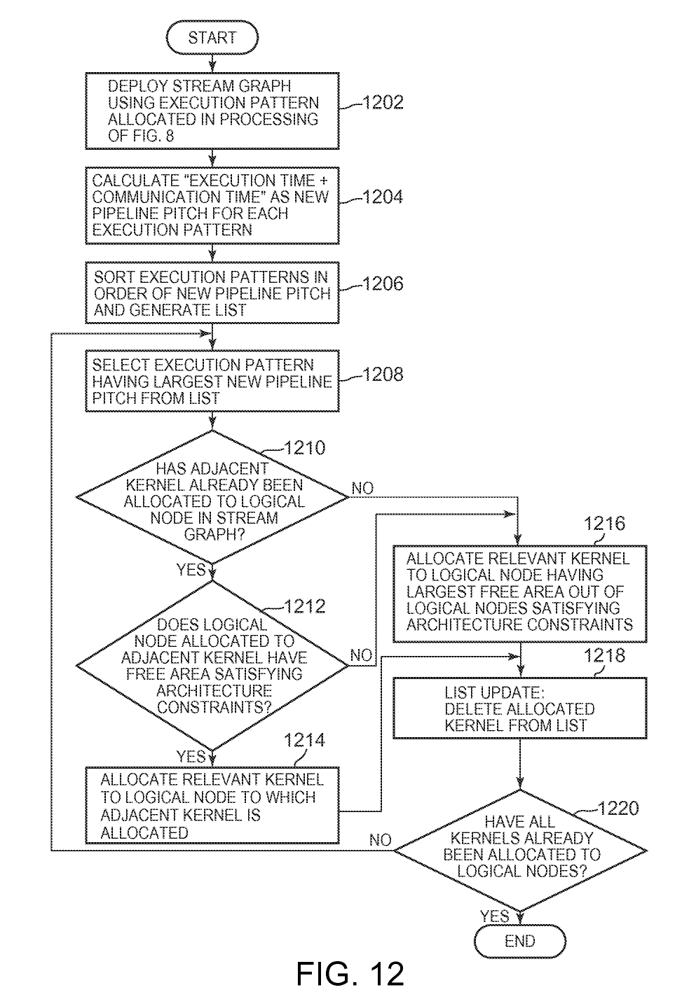

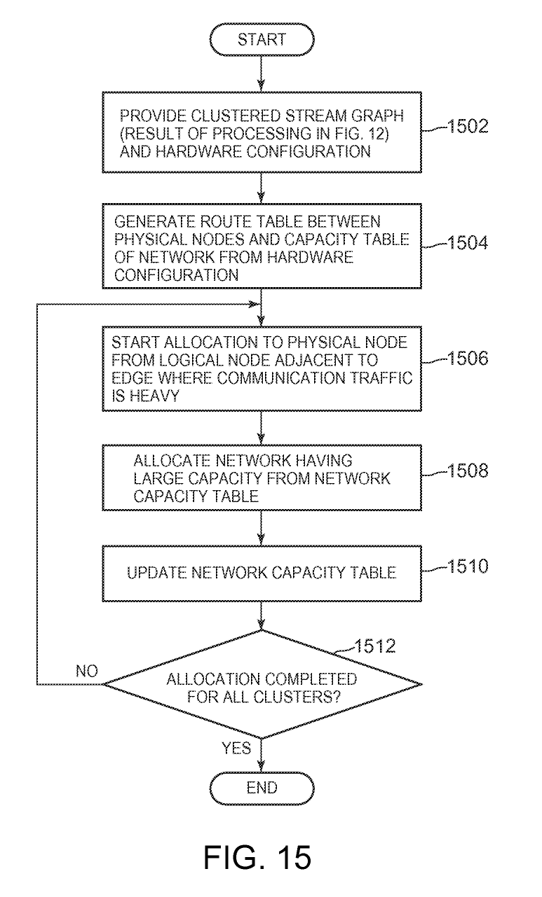

In step 702, the compiler 206 allocates computational resources to operators, namely UDOPs. This process will be described in detail later with reference to the flowchart of FIG. 8. In step 704, the compiler 206 clusters computational resources according to the node configuration. This process will be described in detail later with reference to the flowchart of FIG. 12. In step 706, the compiler 206 allocates logical nodes to the network of physical nodes and determines the communication method between the nodes. This process will be described in detail later with reference to the flowchart of FIG. 15. Subsequently, the computational resource allocation to UDOPs in step 702 will be described in more detail with reference to the flowchart of FIG. 8.

In FIG. 8, it is assumed that the stream graph format source code 212 (stream graph) 212, the resource constraints (hardware configuration), and the optimization table 210 are prepared in advance. FIG. 9 shows an example of the stream graph 212 made of functional blocks A, B, C, and D and the resource constraints.

The compiler 206 performs filtering in step 802. In other words, the compiler 206 extracts only the provided hardware configuration and executable patterns from the optimization table 210 and generates an optimization table (A).

The compiler 206 generates an execution pattern group (B), in which execution patterns having the shortest pipeline pitch are allocated to the respective UDOPs in the stream graph, with reference to the optimization table (A) in step 804. FIG. 10 shows an example of a situation where it is allocated to each block of the stream graph.

Next, in step 806, the compiler 206 determines whether the execution pattern group (B) satisfies the provided resource constraints. If the compiler 206 determines that the execution pattern group (B) satisfies the provided resource constraints in step 806, the process is completed. If the compiler 206 determines that the execution pattern group (B) does not satisfy the provided resource constraints in step 806, the control proceeds to step 808 to generate a list (C) in which the execution patterns in the execution pattern group (B) are sorted in the order of the pipeline pitch.

Thereafter, the control proceeds to step 810, where the compiler 206 selects a UDOP (D) having an execution pattern with the shortest pipeline pitch from the list (C). Then, the control proceeds to step 812, where the compiler 206 determines whether the optimization table (A) contains an execution pattern (next candidate) (E) consuming less resources with respect to UDOP (D).

If so, the control proceeds to step 814, where the compiler 206 determines whether the pipeline pitch of the execution pattern (next candidate) (E) is smaller than the longest value in the list (C), with respect to the UDOP (D). If (E) is smaller, the control proceeds to step 816, where the compiler 206 allocates the execution pattern (next candidate) (E) as a new execution pattern for the UDOP (D) and then updates the execution pattern group (B).

The control returns from step 816 to step 806 for the determination. If the determination in step 810 or step 812 is negative, the control proceeds to step 818, where the compiler 206 removes the UDOP from the list (C). Thereafter, the control proceeds to step 820, where the compiler 206 determines whether an element exists in the list (C). If so, the control returns to step 808.

If the compiler 206 determines that no element exists in the list (C) in step 820, the control proceeds to step 822, where the compiler 206 generates a list (F) in which the execution patterns in the execution pattern group (B) are sorted in the order of a difference between the longest pipeline pitch of the execution pattern group (B) and the pipeline pitch of the next candidate.

Next, in step 824, the compiler 206 determines whether the execution pattern (G) having the smallest difference in the pipeline pitch in the list (F) requires less resources than the currently noted resources. If so, the control proceeds to step 826, where the compiler 206 allocates the execution pattern (G) as a new execution pattern and updates the execution pattern group (B), and then the control proceeds to step 806. Otherwise, the compiler 206 removes the relevant UDOP from the list (F) in step 828 and the control returns to step 822.

FIG. 11 shows a diagram illustrating an example of the foregoing optimization by replacement of the execution pattern group according to an embodiment of the present invention. In FIG. 11, D4 is replaced with D5 in order to remove the resource constraints.

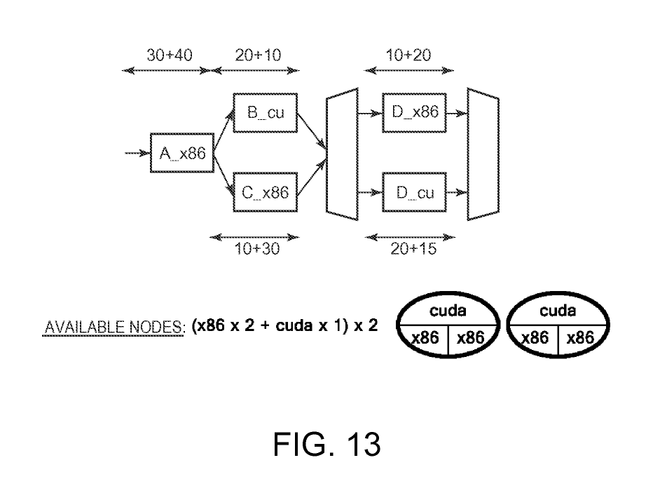

FIG. 12 shows a flowchart illustrating in more detail the clustering of the computational resources according to the node configuration in step 704 according to an embodiment of the present invention. First, in step 1202, the compiler 206 deploys the stream graph using the execution pattern allocated in the processing of the flowchart shown in FIG. 8. An example of this result is shown in FIG. 13. In FIG. 13, cuda is abbreviated as cu.

Next, in step 1204, the compiler 206 calculates the “execution time+communication time” as new pipeline pitch for each execution pattern. In step 1206, the compiler 206 generates a list by sorting the execution patterns based on the new pipeline pitches. Subsequently, in step 1208, the compiler 206 selects the execution pattern having the largest new pipeline pitch from the list. Next, in step 1210, the compiler 206 determines whether the adjacent kernel has already been allocated to a logical node in the stream graph. If the compiler 206 determines that the adjacent kernel has already been allocated to the logical node in the stream graph in step 1210, the control proceeds to step 1212, where the compiler 206 determines whether the logical node allocated to the adjacent kernel has a free area satisfying the architecture constraints.

If the compiler 206 determines that the logical node allocated to the adjacent kernel has the free area satisfying the architecture constraints in step 1212, the control proceeds to step 1214, where the relevant kernel is allocated to the logical node to which the adjacent kernel is allocated. The control proceeds from step 1214 to step 1218. On the other hand, if the determination in step 1210 or step 1212 is negative, the control directly proceeds from there to step 1216, where the compiler 206 allocates the relevant kernel to a logical node having the largest free area out of logical nodes satisfying the architecture constraints.

Subsequently, in step 1218 to which the control proceeds from step 1214 or from step 1216, the compiler 206 deletes the allocated kernel from the list as a list update. Next, in step 1220, the compiler 206 determines whether all kernels have been allocated to logical nodes. If so, the processing is terminated.

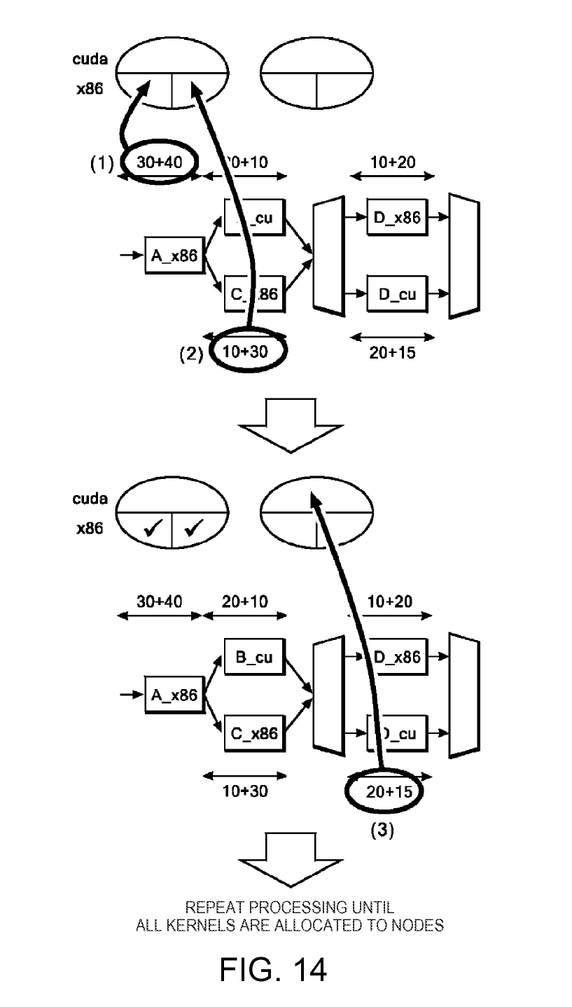

If the compiler 206 determines that all kernels are not allocated to logical nodes in step 1220, the control returns to step 1208. An example of the node allocation is shown in FIG. 14. Specifically, this processing is repeated until all kernels are allocated to the nodes. Note that cuda is abbreviated as cu in a part of FIG. 14.

FIG. 15 shows a flowchart illustrating the processing of allocating the logical nodes to the network of the physical nodes and determining the communication method between the nodes in step 706 in more detail according to an embodiment of the present invention.

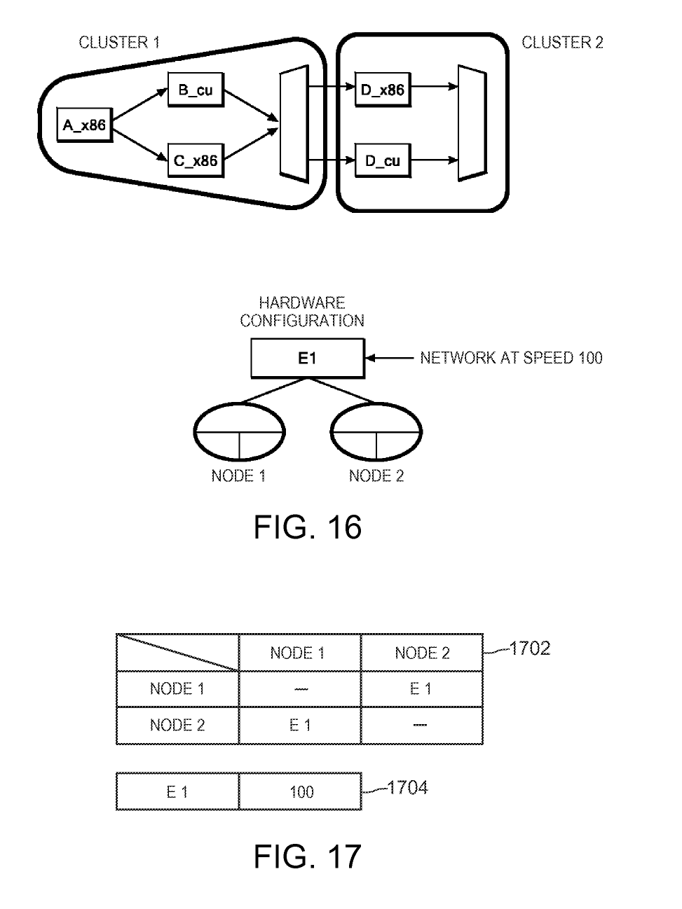

In step 1502, the compiler 206 provides a clustered stream graph (a result of the flowchart shown in FIG. 12) and a hardware configuration. An example thereof is shown in FIG. 16 according to an embodiment of the present invention. In step 1504, the compiler 206 generates a route table between physical nodes and a capacity table of a network from the hardware configuration. FIG. 17 shows the route table 1702 and the capacity table 1704 as an example according to an embodiment of the present invention.

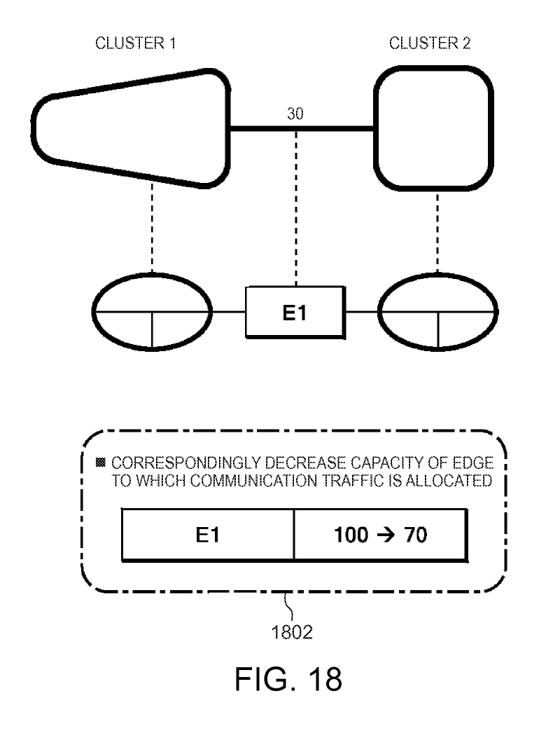

In step 1506, the compiler 206 starts allocation to a physical node from a logical node adjacent to an edge where communication traffic is heavy. In step 1508, the compiler 206 allocates a network having a large capacity from the network capacity table. As a result, the clusters are connected as shown in FIG. 18 according to an embodiment of the present invention.

In step 1510, the compiler 206 updates the network capacity table. It is represented by a box 1802 in FIG. 18. In step 1512, the compiler 206 determines whether the allocation is completed for all clusters. If so, the processing terminates. Otherwise, the control returns to step 1506.

Although the present invention has been described hereinabove in connection with particular embodiments, it should be understood that the shown hardware, software, and network configuration are merely illustrative and the present invention is achievable by an arbitrary configuration functionally equivalent to those.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A method for optimizing performance of an application running on a hybrid system, said method comprising the steps of:
selecting a first user defined operator from a library component within said application;
determining at least one available hardware resource;
generating at least one execution pattern for said first user defined operator based on said at least one available hardware resource;
compiling said at least one execution pattern;
measuring an execution speed of said at least one execution pattern on said at least one available hardware resource; and
storing said execution speed and said at least one execution pattern in an optimization table;
wherein at least one of the steps is carried out using a computer device so that performance of said application is optimized on said hybrid system.

2. The method according to claim 1, further comprising the steps of:
preparing a source code of the application to run within said hybrid system;
creating a filtered optimization table by filtering said optimization table to only contain said execution speed for said at least one available hardware resource;
creating a first optimum execution pattern group for said first user defined operator by allocating, from said filtered optimization table, said at least one execution pattern to said first user defined operator wherein said at least one execution pattern has a shortest pipeline pitch; and
determining whether said first optimum execution pattern group satisfies a resource constraint.

3. The method according to claim 2, further comprising the step of:
replacing, if said first optimum execution pattern group satisfies said resource constraint, an original execution pattern group applied to said source code with said first optimum execution pattern group.

4. The method according to claim 2, further comprising the steps of:
generating a list by sorting said at least one execution patterns within said first optimum execution pattern group by pipeline pitch;
determining a second user defined operator which has an execution pattern with a shortest pipeline pitch from said list;
determining whether said filtered optimization table contains a second execution pattern which consumes less resources than said second user defined operator;
determining, if said second execution pattern exists, whether a second pipeline pitch of said second execution pattern is less than a longest pipeline pitch of said second user defined operator within said list;
allocating, if said second pipeline pitch is less than said highest pipeline pitch, said second execution pattern to said second user defined operator; and
removing, if said second pipeline pitch is not less than said highest pipeline pitch, said second execution pattern from said list.

5. The method according to claim 4, further comprising the steps of:
generating, if an element does not exist in said list, a second list by sorting said at least one execution patterns within said first optimum execution pattern group by a metric wherein said metric is a difference between the longest pipeline pitch within said first optimum execution pattern group and a third pipeline pitch of a next execution pattern;
identifying a lowest execution pattern which has the lowest metric;
allocating, if said lowest execution pattern has the lowest metric, said lowest execution pattern to said second user defined operator; and
removing, if said lowest execution pattern does not have the lowest metric, said second user defined operator from said list.

6. The method according to claim 2 wherein said source code is in a stream graph format.

7. The method according to claim 1, wherein:
said at least one available hardware resources are connected to each other via a network; and
said hybrid system permits nodes having mutually different architectures to be mixed.

8. The method according to claim 6, further comprising the steps of:
arranging edges on a stream graph in descending order based on the communication size to generate an edge list; and
allocating two operations sharing a head on said edge list to the same hardware resource.

9. The method according to claim 1, further comprising the step of:
acquiring a kernel definition for performing said user defined operator;
wherein said at least one execution pattern is also based on said kernel definition.

10. A system for optimizing performance of an application running on a hybrid system which (1) permits nodes having mutually different architectures to be mixed and (2) connects a plurality of hardware resources to each other via a network and, the system comprising:
a storage device;
a library component for generating the application stored in said storage device;
a selection module adapted to select a first user defined operator from a library component within said application;
a determination module adapted to determine at least one available hardware resource;
a generation module adapted to generate at least one execution pattern for said first user defined operator based on said at least one available hardware resource;
a measuring module adapted to measure an execution speed of said at least one execution pattern using said at least one available hardware resource; and
a storing module adapted to store said execution speed and said at least one execution pattern in an optimization table.

11. The system according to claim 10, further comprising:
a source code of said application stored in said storage device;
an applying module adapted to apply said at least one execution pattern in said optimization table to a user defined operator of said application so as to achieve the minimum execution time; and
a replacing module adapted to replace an execution pattern applied to the operation in the source code with said at least one execution pattern with the minimum execution time if said at least one execution pattern with the minimum execution time satisfies constraints of said at least one available hardware resource.

12. The system according to claim 11, further comprising:
a sorting module adapted to sort and list said at least one execution pattern on a stream graph by the execution time; and
a replacing module adapted to replace a first execution pattern with an second execution pattern which consumes less computational resources;
wherein said source code is in a stream graph format.

13. The system according to claim 12, further comprising:
an generating module adapted to generate an edge list by arranging edges on said stream graph in descending order based on a communication size; and
an allocation module adapted to allocate two operations sharing a head on said edge list to the same hardware resource.

14. A computer readable storage medium tangibly embodying a computer readable program code having computer readable instructions which when implemented, cause a computer to carry out the steps of a method comprising:
selecting a first user defined operator from a library component within said application;
determining at least one available hardware resource;
generating at least one execution pattern for said first user defined operator based on said at least one available hardware resource;
compiling said at least one execution pattern;
measuring an execution speed of said at least one execution pattern on said at least one available hardware resource; and
storing said execution speed and said at least one execution pattern in an optimization table.

15. The computer readable storage medium according to claim 14, further comprising the steps of:
preparing a source code of the application to run within said hybrid system;
creating a filtered optimization table by filtering said optimization table to only contain said execution speed for said at least one available hardware resource;
creating a first optimum execution pattern group for said first user defined operator by allocating, from said filtered optimization table, said at least one execution pattern to said first user defined operator wherein said at least one execution pattern has a shortest pipeline pitch; and
determining whether said first optimum execution pattern group satisfies a resource constraint.

16. The computer readable storage medium according to claim 15, further comprising the step of:
replacing, if said first optimum execution pattern group satisfies said resource constraint, an original execution pattern group applied to said source code with said first optimum execution pattern group.

17. The computer readable storage medium according to claim 15, further comprising the steps of:
generating a list by sorting said at least one execution patterns within said first optimum execution pattern group by pipeline pitch;
determining a second user defined operator which has an execution pattern with a shortest pipeline pitch from said list;
determining whether said filtered optimization table contains a second execution pattern which consumes less resources than said second user defined operator;
determining, if said second execution pattern exists, whether a second pipeline pitch of said second execution pattern is less than a longest pipeline pitch of said second user defined operator within said list;
allocating, if said second pipeline pitch is less than said highest pipeline pitch, said second execution pattern to said second user defined operator; and
removing, if said second pipeline pitch is not less than said highest pipeline pitch, said second execution pattern from said list.

18. The computer readable storage medium according to claim 17, further comprising the steps of:
generating, if an element does not exist in said list, a second list by sorting said at least one execution patterns within said first optimum execution pattern group by a metric wherein said metric is a difference between the longest pipeline pitch within said first optimum execution pattern group and a third pipeline pitch of a next execution pattern;
identifying a lowest execution pattern which has the lowest metric;
allocating, if said lowest execution pattern has the lowest metric, said lowest execution pattern to said second user defined operator; and
removing, if said lowest execution pattern does not have the lowest metric, said second user defined operator from said list.

19. The computer readable storage medium according to claim 15, wherein said source code is in a stream graph format.

20. The computer readable storage medium according to claim 19, further comprising the steps of:
arranging edges on a stream graph in descending order based on the communication size to generate an edge list; and
allocating two operations sharing a head on said edge list to the same hardware resource.
